(19) United States
(12) Patent Application Publication
(10) Pub. No.: US 2013/0268989 A1
(43) Pub. Date: Oct. 10, 2013

(54) METHOD AND SYSTEM FOR DYNAMICALLY ALOCATING POPULAR CONTENT

(71) Applicants: Richard Gordon LAWSON, Erin (CA); Christopher ZUPPAN, Erin (CA)

(72) Inventors: Richard Gordon LAWSON, Erin (CA); Christopher ZUPPAN, Erin (CA)

(73) Assignee: ROGERS COMMUNICATIONS INC., Toronto (CA)

(21) Appl. No.: 13/439,303

(22) Filed: Apr. 4, 2012

(51) Int. Cl. H04N 21/60

(52) U.S. Cl. 725/118

(57) ABSTRACT

Methods and devices for dynamically allocating popular content to multi-node transmission channels are described. In one aspect, a method, performed by a content delivery system is described. The content delivery system comprises a termination system configured to deliver content to a plurality of nodes over a plurality of transmission channels. The method comprises: allocating transmission channels as multi-node transmission channels, each multi-node transmission channel being configured to distribute content from the termination system to a plurality of nodes; allocating transmission channels as single-node transmission channels, each single-node transmission channel being configured to distribute content from the termination system to a single node; and selecting content for transmission in the multi-node transmission channels based on content usage data.

### TECHNICAL FIELD

The present disclosure relates to content delivery systems and, more particularly, to methods and systems for managing bandwidth in content delivery systems.

### BACKGROUND

Content delivery systems, such as cable television systems, satellite television systems and Internet protocol television systems (IPTV), often deliver content, such as television programming, from a head end system operated by a service provider to one or more receivers operating within the content delivery system.

Such content delivery systems often have a limited amount of bandwidth available to deliver content. For example, wireless content delivery systems such as satellite television systems may be required to deliver signals within a specific portion of the wireless spectrum. Similarly, wired content delivery systems, such as cable television systems, operate over a wired transmission medium which has limited bandwidth.

The availability of bandwidth for content delivery may be further limited where service providers act as Multiple System Operators (MSO), providing multiple services over common transmission mediums. For example, service providers may operate a voice communication service and/or an Internet service over a transmission medium (such as a network of cables) which they also use for content delivery system services (such as television delivery services). Each of these services may require bandwidth in the transmission medium, thus reducing the overall availability of bandwidth in the transmission medium.

Adding additional bandwidth to existing content delivery systems may be a difficult and costly endeavor. For example, in order to add additional bandwidth to a cable television system, it may be necessary to expand existing infrastructure by laying new cables.

Thus there exists a need for systems and methods to better manage existing bandwidth.

### BRIEF DESCRIPTION OF THE DRAWINGS

FIG. 1 is a block diagram of an example content delivery system in accordance with example embodiments of the present disclosure;

FIG. 2 is a flowchart of a method for managing bandwidth in accordance with example embodiments of the present disclosure;

FIG. 3 is an example bar graph illustrating content usage data for use in accordance with example embodiments of the present disclosure; and

FIG. 4 is a flowchart of a method for managing bandwidth in accordance with example embodiments of the present disclosure.

Like reference numerals are used in the drawings to denote like elements and features.

### DETAILED DESCRIPTION OF EXAMPLE EMBODIMENTS

In one aspect, the present disclosure describes a method, performed by a content delivery system. The content delivery system includes a termination system configured to deliver content to a plurality of nodes over a plurality of transmission channels. The method includes: allocating transmission channels as multi-node transmission channels, each multi-node transmission channel being configured to distribute content from the termination system to a plurality of nodes; allocating transmission channels as single-node transmission channels, each single-node transmission channel being configured to distribute content from the termination system to a single node; and selecting content for transmission in the multi-node transmission channels based on content usage data.

In another aspect, the present disclosure describes a content delivery system for delivering content to a plurality of end user devices. The end user devices are connected to a node of the content delivery system. The content delivery system includes at least one termination system for delivering content to a plurality of the nodes over a plurality of transmission channels. The content delivery system also includes a memory and a processor coupled to the memory and the termination system. The processor is configured to: allocate transmission channels as multi-node transmission channels, each multi-node transmission channel being configured to distribute content from the termination system to a plurality of nodes; allocate transmission channels as single-node transmission channels, each single-node transmission channel being configured to distribute content from the termination system to a single node; and select content for transmission in the multi-node transmission channels based on content usage data.

In yet another aspect, the present disclosure describes a computer readable storage medium. The computer readable storage medium includes computer executable instruction which, when executed, cause a processor to: allocate transmission channels as multi-node transmission channels, each multi-node transmission channel being configured to distribute content from the termination system to a plurality of nodes; allocate transmission channels as single-node transmission channels, each single-node transmission channel being configured to distribute content from the termination system to a single node; and select content for transmission in the multi-node transmission channels based on content usage data.

Other example embodiments of the present disclosure will be apparent to those of ordinary skill in the art from a review of the following detailed description in conjunction with the drawings.

### Example Content Delivery System

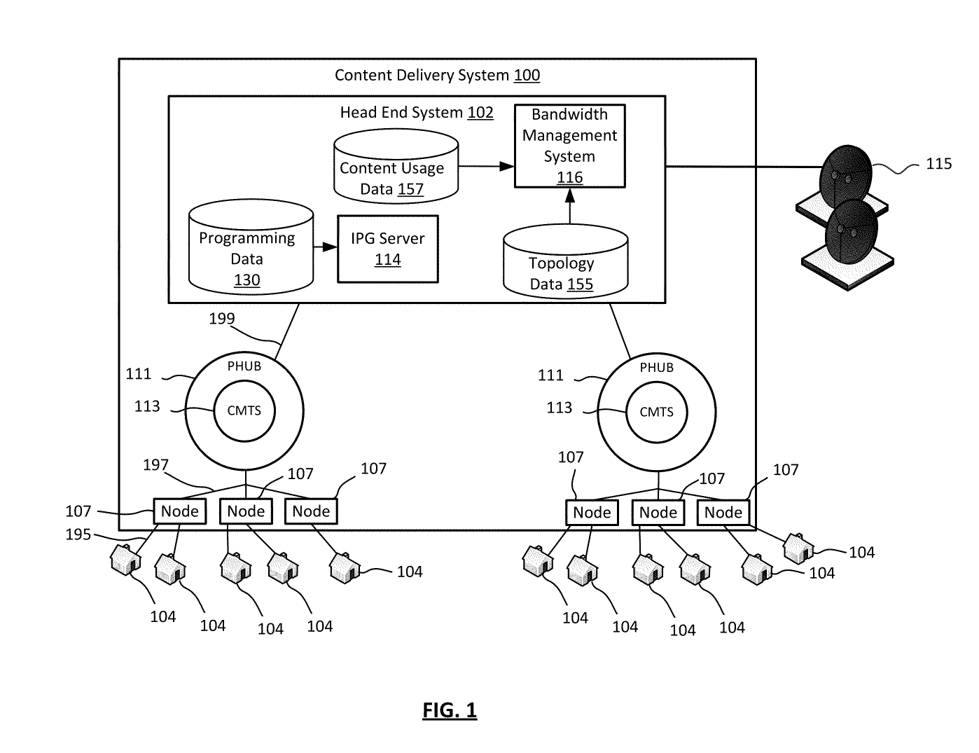

Referring now to FIG. 1, a block diagram of an example content delivery system 100 is illustrated in which example embodiments of the present disclosure may be applied. The content delivery system 100 is configured to deliver content from a content source system to a content destination system.

In the example embodiment illustrated, the system from which content is delivered (i.e. the content source system) is referred to as a head end system 102 and the system receiving the content (i.e. the content destination system) for presentation on a media player (such as a television), is referred to as a receiver 104, an end user device or Customer Premises Equipment (CPE).

In at least some example embodiments, the content delivery system 100 is a broadcast television system which delivers television content such as broadcast television shows. The content delivery system 100 may provide a subscription-based content delivery service in which each receiver 104 operating in the content delivery system 100 may be associated with a subscriber to the content delivery system 100. Each subscriber may be authorized to view specific content. For example, each subscriber may be authorized to view a specific set of broadcast streams associated with channels which the subscriber subscribes to. The content delivery system 100 may deliver content to a plurality of subscribers associated with a plurality of receivers 104.

The head end system 102 may be owned and/or operated by a content service provider such as a television service provider; for example, such as a cable television service provider and/or a satellite television service provider.

The receivers 104 are typically located in a location associated with a subscriber such as, for example, the home of a subscriber. Accordingly, in at least some example embodiments, the receivers 104 may be referred to as Customer Premises Equipment (CPE). A receiver 104 may be connected to a media player, such as a television, on which content received at the receiver 104 may be displayed. In at least some example embodiments, a receiver 104, or parts thereof, may be internal to a media player (e.g. the television). For example, a receiver 104 may be a component of a television which is included in the television at the time of manufacture. In other embodiments, a receiver 104 may be an external receiver 104 which is connected to the media player (e.g. the television) through a wired or wireless transport medium.

The receivers 104 are illustrated in FIG. 1 using houses to illustrate that the receivers 104 may be distributed among different households associated with different subscribers. However, it will be appreciated that a single household may, in some embodiments, include multiple receivers 104 and that receivers 104 need not, in all embodiments, be located within houses.

One or more of the receivers 104 which are serviced by the content delivery system 100 may, in at least some example embodiments, be a set top box. A set top box is a device which connects to a television (or other display) and an external source of signal, turning the signal into content which may be displayed on the television (or other display). The term set top box includes devices which do not, necessarily, sit on top of a television. That is, the term set top box may refer to any device which is external to a television (or other display) and which receives an external signal, turns the signal into content and displays the signal on the display.

The receivers 104 may also take other forms including, for example, a gaming console, a cable card, a personal computer, a tablet device, a smartphone, etc. The receivers 104 may be any electronic devices at which content from a head end system 102 may be received.

The receivers 104 are connected to the head end system 102 through transport mediums 195, 197, 199 which may, in various embodiments, include wired transport medium (such as coaxial cable and/or fibre optic cable) and/or wireless transport medium (such as radio frequency (RF) based transport mediums).

In the embodiment illustrated, the content delivery system 100 is a wired television delivery system, such as a cable television system, which delivers content to the receivers 104 primarily over wired transport mediums 195, 197, 199. The wired transport mediums 195, 197, 199 may include cables. The wired transport mediums 195, 197, 199 may, in various embodiments, include copper, or other wires, such as coaxial cable and/or may include an optical transport medium, such as fibre optic cables. In the example embodiment illustrated, the content delivery system 100 may also be referred to as a cable network.

In other embodiments, the methods described herein may be applied to other types of content delivery systems 100. For example, in at least some embodiments, one or more of the methods described herein may be applied to a wireless television system, such as a satellite television system, which delivers content to receivers 104 primarily over a wireless transport medium.

As illustrated in FIG. 1, the head end system 102 may not be connected directly to the receivers 104. In at least some embodiments, one or more intermediary systems or devices may facilitate the distribution of content from the head end system 102 to the receivers 104. For example, in at least some embodiments, a hub 111 (which may also be referred to as a distribution hub) may connect to the head end system 102. The hub 111 may be connected to the head end system 102 through a transport medium 199. In at least some embodiments, the transport medium 199 connecting the head end system 102 to the hub 111 may be a high bandwidth transport medium, such as a fibre cable.

In the example embodiment illustrated, the content delivery system 100 includes two hubs 111. However, in other embodiments, the content delivery system 100 may include a different number of hubs. The exact number of hubs in the content delivery system 100 will depend, in part, on the number of receivers 104 serviced by the content delivery system 100. In the example embodiment illustrated, the hubs 111 are primary hubs (PHUB). A primary hub is a location from which a content delivery service may be delivered from. A secondary hub is a remotely located extension of a primary hub.

Each hub 111 may service a set of nodes 107. That is, each hub 111 may function to deliver content to a specific node 107, or set of nodes 107. In the example embodiment illustrated, each hub 111 is connected to and services three nodes 107. However, in practice, the number of nodes serviced by each hub 111 may be much greater. Transport mediums 197 may connect the hubs 111 to the nodes 107. In at least some embodiments, the transport mediums 197 connecting the hubs 111 to the nodes 107 are high bandwidth transport mediums, such as a fibre cables.

Each node 107 may be connected to a set of receivers 104. That is, each node 107 may deliver content received from the head end system 102 (via the hub 111) to one or more of the receivers 104 connected to that node 107. In the example embodiment illustrated, there are two receivers connected to each node 107. However, in practice, the number of receivers 104 connected to the nodes 107 may be much greater. Each node 107 may service receivers 104 in a specific geographic area.

Transport mediums 195 may connect the nodes 107 to the receivers 104. The transport mediums connecting the nodes 107 to the receivers 104 may include low bandwidth transport mediums, such as copper cable (e.g. coaxial cable).

Various components of the content delivery system 100 and the receivers 104 may define a topology for the content delivery system 100. The topology for the content delivery system 100 defines the form of interconnections of the components of the content delivery system 100 and the receivers 104. That is, the term topology is used to describe the manner by which a receiver 104 connects to content delivery system 100 to receive content. Each receiver 104 may connect to the head end system 102 via a specific hub 111, a specific termination system 113 (the termination system 113 will be described below) and a specific node 107. These specific connections define the topology of the content delivery system 100. In at least some embodiments, the content delivery system 100 may track this topology. For example, the content delivery system 100 may, in at least some embodiments, obtain topology data 155 specifying specific components (e.g. the specific nodes 107 and/or hubs 111 and/or termination systems 113) which connect a receiver 104 to the head end system 102. For example, the topology data 155 may specify the path from the head end system 102 to each receiver 104 services by the content delivery system 100.

The topology data 155 may be stored in memory of the content delivery system 100. In some example embodiments, the memory includes non-volatile memory, such as flash memory. In at least some example embodiments, the memory includes a solid state drive (SSD) and/or a magnetic storage, such as a hard disk drive (HDD). Other types of memory may be used instead of or in addition to those listed above. In the example embodiment illustrated, the topology data 155 is stored in memory of the head end system 102. However, in other embodiments, the topology data 155 may be stored elsewhere.

The topology data 155 may, in at least some embodiments, be automatically generated. For example, the topology data 155 may be generated by sending data from the head end system 102 to a receiver 104 and by tracking the components which are used in the transmission of the data. Other methods of generating the topology data 155 may be used in other embodiments. The topology data 155 may be repeatedly updated to account for receivers 104 brought online or offline in the content delivery system 100.

The content delivery system 100 may include one or more termination systems 113. The termination systems 113 may be located in the head end system 102 and/or in a hub 111 (such as a primary hub (PHUB) and/or a secondary hub (SHUB)). In the embodiment illustrated, the termination systems 113 are located in the hubs 111.

In at least some embodiments, the termination systems 113 are cable modem termination systems (CMTS). A CMTS is a component which is used to provide high speed data services to cable subscribers. In the example embodiment illustrated, the CMTS is used to provide high speed content delivery services. That is, the CMTS is used to deliver content, such as television programming, to the receivers 104. More particularly, the CMTS is configured to service a specific set of nodes (i.e. to send content to those nodes), thereby servicing the receivers connected to those nodes.

The CMTS may be used to provide multiple services to subscribers. That is, the CMTS may be used by a multiple system operator to provide a plurality of services, such as data (e.g. Internet), voice (e.g. phone), and/or video (e.g. television) services to subscribers. In at least some embodiments, the content delivery system 100 may be configured to deliver services accordingly to a Data Over Cable Service Interface Specification (DOCSIS). DOCSIS is an international telecommunications standard that permits high-speed data transfer to occur over cable TV (CATV) infrastructure. Accordingly, in at least some embodiments, the CMTS may be configured to operate according to a DOCSIS specification.

The head end system 102 and the receivers 104 are configured to permit downstream communications to the receivers 104 through respective transport mediums and protocols. More particularly, the head end system 102 and the receivers 104 are configured to permit content, such as television content, to be delivered to the receivers 104 for display on media players (such as a television) associated with respective receivers. Where the content delivery system 100 is a wired television system, such as a cable television system, the head end system 102 may deliver content to the receiver 104 through the wired transport mediums 195, 197, 199.

The head end system 102 is configured to gather content (such as programming sources, including source broadcast streams), decode, select and/or retransmit such content (such as video programming) to a distribution network, which includes the one or more receivers 104.

The head end system 102 may include or connect to a content acquisition system 115. The content acquisition system 115 of FIG. 1 is illustrated as a plurality of satellite dishes. Such satellite dishes may be configured to receive content from one or more satellites. In various embodiments, the content acquisition system 115 may be configured to receive content through other means instead of, or in addition to, the satellite dishes. For example, the content acquisition system 115 may include one or more antennas which receive radio frequency signals, such as signals transmitted through a terrestrial based network. In at least some embodiments, the content acquisition system 115 may be configured to receive content through a network, such as the Internet. In at least some embodiments, the content acquisition system 115 may be configured to receive content though a wired transport medium such as, for example, a cable. The cable may, in some example embodiments, include a coaxial cable and/or a fibre optic cable. The content received through the content acquisition system 115 may include, for example, broadcast content which may be received in streaming fashion from one or more television networks. Such content may be referred to as source broadcast streams.

In order to prevent unauthorized access to content (such as source broadcast streams), such content may be scrambled or otherwise encrypted. The head end system 102 may receive scrambled and/or encrypted content (such as encrypted source broadcast streams). Such encrypted and/or scrambled content may, for example, be received at the content acquisition system 115. The head-end system 102 may be configured to decrypt or decode such content. In at least some example embodiments, the content management system 117 of the head end system 102 may be configured to perform such decryption and/or decoding.

The head end system 102 may transmit content, such as video to subscribers over a network. In at least some embodiments, prior to such transmissions, the head-end system 102 may encrypt the signal using its own encryption algorithm in order to prevent unauthorized access to the signal, such as eavesdropping and theft of service. In at least some example embodiments, the content management system 117 of the head end system 102 may include subsystems and modules which are configured to perform or facilitate such transmission, formatting, modulation and/or encryption of content.

The content delivery system 100 may be configured to utilize digital technology to deliver digital content, such as video signals. Digital video signals are signals which use digital video compression. In at least some embodiments, the content delivery system 100 may be configured to encode and transmit video signals according to a Quadrature Amplitude Modulation (QAM) format. QAM is a modulation format which does not specify the format of the digital data being carried. The format of the data being carried may, in at least some example embodiments, be based on an Advanced Television Systems Committee (ATSC) standard. In other some embodiments, the content delivery system 100 may be configured to use a Digital Video Broadcasting (DVB) based data format, such as Digital Video Broadcasting—Cable (DVB-C), to format the data being carried (such as video signals). In at least some example embodiments, the content delivery system 100 may be configured to transmit data formatted according to a Motion Pictures Experts Group (MPEG) standard, such as an MPEG-2 or MPEG-4 digital audio/digital video stream. In at least some example embodiments, the content delivery system 100 may be configured to use QAM modulation on such data.

Other data formats or modulation formats may be used to format or transmit content streams, including, for example, variations and evolutions of the standards discussed above. By way of example, in at least some embodiments, a second generation Digital Video Broadcasting—Cable (DVB-C2) format may be used.

The head-end system 102, in at least some embodiments, includes an interactive programming guide (IPG) server 114. The IPG server 114 is configured to process metadata associated with content. The metadata may be associated with on-demand content and/or broadcast content. The metadata may, for example, be stored in a programming data store 130. The programming data store 130 may include programming data such as the metadata associated with content and scheduling information. The scheduling information may also include time and date information specifying the time and/or date when content will be available. The metadata associated with broadcast content may be referred to as broadcast metadata.

The IPG server 114 may be configured to retrieve at least some of the metadata from a metadata service provider and store such metadata in the programming data store 130 of the head end system 102.

The IPG server 114 may be configured to provide programming data to receivers 104. Such programming data may include, for example, the scheduling information and metadata. The IPG server 114 may provide programming data regarding broadcast content and may also be configured to provide programming data regarding on-demand content which is available for download to the receivers. For example, the IPG server 114 may be configured to provide to receivers 104 information regarding on-demand content stored in a content store accessible by the head end system 102. Such information may be referred to as on-demand content metadata. Metadata associated with broadcast content may be referred to as broadcast metadata. The on-demand content metadata and the broadcast metadata may, for example, include a description of content associated with the metadata including, for example, a title, summary, viewing time, and/or price associated with the metadata. The metadata may include other information instead of or in addition to the information specified above.

In at least some example embodiments, the content delivery system 100 may be configured to control the allocation of fixed resources, such as bandwidth in the content delivery system 100. In order to manage bandwidth, the content delivery system 100 may include one or more bandwidth management systems 116 which are configured to manage bandwidth in the content delivery system 100. The bandwidth management system 116 may also be referred to as resource management systems.

In the example embodiment of FIG. 1, the bandwidth management system 116 is included in the head end system 102. However, the bandwidth management system 116 could, in other embodiments, be included in or associated with other components of the content delivery system 100. In some embodiments, bandwidth management systems 116 are included in the termination systems 113.

As will be discussed in greater detail below, in at least some embodiments, a bandwidth management system 116 may be configured to manage bandwidth between the termination systems 113 (such as the CMTS) and the nodes 107. In at least some embodiments, the bandwidth management system 116 allocates a predetermined number of transmission channels for each termination system 113 as multi-node transmission channels. Each multi-node transmission channel is configured to distribute content simultaneously to a plurality of nodes. In at least some embodiments, each multi-node transmission channel of the termination system is configured to deliver content to all nodes connected to that termination system 113. That is, the multi-node transmission channels of the termination system 113 is used to broadcast content to all nodes connected to the termination system 113. The multi-node transmission channel is a transmission channel which may be accessed by all nodes connected to that termination system. In at least some embodiments, four transmission channels of each termination system 113 are allocated as multi-node transmission channels.

Similarly, the bandwidth management system 116 allocates some transmission channels of the termination system 113 as single-node transmission channels. Each single-node transmission channel is configured to distribute content from the termination system 113 to a single node 107 connected to that termination system 113. That is, each single-node transmission channel is used for transmitting content to a specific node 107 (and is not used for transmitting content to other nodes 107). A single-node transmission channel is reserved for a specific node and is always used for transmitting content to that node. In at least some embodiments, the termination system 113 allocates a common number of single-node transmission channels for each node 107 to ensure that all nodes 107 have equal access to content. In at least some embodiments, each node 107 is allocated three single-node transmission channels. However, the nodes 107 may be allocated a different number of transmission channels in other embodiments.

The bandwidth management system 116 is configured to select content for transmission in the multi-node transmission channels based on usage data. That is, the bandwidth management system 116 is configured to use multi-node transmission channels to deliver content which is relatively more popular and to use the single-node transmission channels to deliver content which is relatively less popular.

In at least some example embodiments, the content delivery system 100 provides for upstream communications from one or more of the receivers 104 to the head end system 102 (and/or other components of the content delivery system 100). In at least some example embodiments, upstream communications (i.e. communications originating from a receiver 104 which are sent to the head end system 102) may operate on the same transport mediums 195, 197, 199 and/or transport protocol as the downstream communications (downstream communications are communications originating from the head end system 102 which are sent to one or more receiver 104). For example, in a wired television system, such as a cable television system, communications originating from a receiver 104 may be sent to the head end system 102 through the wired transport mediums 195, 197, 199.

Accordingly, the head end system 102 and the receivers 104 used in the content delivery systems 100 provide for downstream communications from the head end system 102 to the receivers 104 and may, in at least some example embodiments, provide upstream communications from the receivers 104 to the head end system 102. Such upstream communications may permit the receivers 104 to communicate with the head end system 102. Such upstream communications may, for example, be useful to provide on-demand services to a receiver 104, such as video on-demand services (which may be used to deliver specific video content on request), audio on-demand services (which may be used to deliver specific audio content on request) or application on-demand services (which may be used to deliver specific applications on request) to a receiver 104.

In at least some embodiments, the upstream communications may permit the content delivery system 100 to monitor content usage. That is, such upstream communications may allow the content delivery system 100 to know information about what content is being consumed by the receivers 104. For example, the content delivery system 100 may use such upstream communications to obtain content usage data 157. For example, the content delivery system 100 may store content usage data 157 identifying content which is consumed by the receivers 104. That is, the content delivery system 100 may track content being watched by subscribers.

In at least some embodiments, the bandwidth management system 116 may be configured to provide on-the-fly transitioning of content into the multi-node transmission channels. That is, the bandwidth management system 116 may be configured to monitor the content being consumed and to shift content into the multi-node transmission channels based on the popularity of content. That is, the bandwidth management system 116 may be configured to select content for transmission in the multi-node transmission channels based on content usage data which represents the current popularity of content. In some embodiments, when content being transmitted in a single-node transmission channel becomes more popular than content which is being transmitted in a multi-node transmission channel, that content may be transitioned to the multi-node transmission channel. That is, the less popular content currently being transmitted in the multi-node transmission channel may be transmitted in one or more single-node transmission channels and the popular content currently being transmitted in the single node transmission channel(s) may be transmitted in the multi-node transmission channels.

In at least some embodiments, instead of or in addition to such on-the-fly transitioning of content, the bandwidth management system 116 may be configured to select content for transmission in the multi-node transmission channels based on content usage data 157 which is historical usage data identifying the historic popularity of content. For example, in some embodiments, the bandwidth management system 116 may be configured to obtain a content delivery schedule based on such historic usage data. The content delivery schedule may specify content to be delivered over the multi-node transmission channels and may specify timing information associated with such content. For example, the content delivery schedule may be comprised of thirty (30) minute time slots which begin on each hour and each half hour. The content delivery schedule may specify content to be delivered using the multi-node transmission channels of the termination system 113 at each time slot.

Accordingly, in at least some embodiments, the bandwidth management system 116 may effectively predict user interest in content based on past interest in similar content. In such embodiments, the content usage data 157 may contain information which may be useful in order to predict such user interest in the content. For example, the content usage data 157 may identify historically popular content, or be used to identify historically popular content. For example, the content usage data may quantify historic viewership of television programs, television channels or broadcasters, etc. As noted above, the content usage data 157 may be used in order to select content for transmission in multi-node transmission channels of a termination system 113.

The content usage data 157 may, in some embodiments, be compiled at the head end system 102. That is, the head end system 102 may be configured to identify content being consumed by the receivers 104. In at least some embodiments, the head end system 102 may poll the receivers 104 to determine the content being consumed by the receivers 104.

The content usage data 157 includes data identifying content consumed at the receivers 104. In some embodiments, the data may be based, at least in part, on metadata associated with content (which may be metadata from the programming data store 130). That is, the content usage data 157 may track the popularity of content by using one or more identifiers of content contained in the metadata. For example, the content usage data 157 may store a title of a television series or program and/or may store a title of an episode. Other data may be used to identify content in other embodiments.

The content usage data 157 may, in at least some embodiments, include data identifying whether historical content usage data for that content identifies usage for first-run content or re-run content. First-run content is content which is being broadcast for the first time. Re-run content is content which is being re-aired following a first-run broadcast. Historical content usage data 157 for a first run content may not, in at least some embodiments, be reflective of predicted interest in re-run content. Accordingly, in at least some embodiments, when predicting user interest in content and/or when maintaining the content usage data 157, the bandwidth management system 116 may consider whether the content is first run content or re-run content.

The content usage data may, in at least some embodiments, quantify the popularity of content in terms of viewership. That is, the content usage data may specify the number of receivers 104 that viewed the content.

In at least some embodiments, the content usage data may include timing information associated with the content usage data. For example, the content usage data may specify the viewership of a plurality of television networks at various time slots throughout the day. In at least some embodiments, the timing information may break down the content usage data into half hour slots. That is, the viewership data for each half hour slot may be independently tracked so that the viewership data represents the content being consumed at various times throughout the day. The viewership data may also be independently tracked for each day of the week since content which is popular on one day of the week (e.g. Monday) may not, necessarily, also be popular on another day of the week (e.g. Saturday).

In at least some embodiments, content usage data 157 may be obtained in such a manner that it is possible to associate the content usage data 157 with a specific termination system 113. That is, the content usage data 157 may specify or may be used to specify the popularity of content at receivers 104 serviced by a specific termination system 113. For example, in some embodiments, viewership data which specifies content consumed at the receivers 104 may be correlated with the topology data 155 to identify content which is popular among end user devices (i.e. receivers 104) serviced by a specific termination system 113. For example, in at least some embodiments, viewership data may be obtained which identifies a receiver 104 and which also identifies content being consumed at that receiver. This viewership data may be correlated to the topology data to identify components of the content delivery system 100 which are used to transmit the data to that receiver 104. For example, the termination system 113 which delivers content to that receiver 104 may be identified.

Accordingly, in at least some embodiments, the content usage data 157 allows popular content to be identified on a per-termination system basis. Content which is popular at one termination system 113 may not, in all circumstances and in all embodiments, be popular at another termination system 113. Accordingly, in at least some embodiments, content is selected for transmission in the multi-node transmission channels independently for each termination system 113. For example, a first termination system 113 may transmit content in its multi-node transmission channel which is not transmitted in the multi-node transmission channel of a second termination system 113.

In at least some embodiments, content usage data 157 may be stored in memory of the content delivery system 100. In some example embodiments, the memory includes non-volatile memory, such as flash memory. In at least some example embodiments, the memory includes a solid state drive (SSD) and/or a magnetic storage, such as a hard disk drive (HDD). Other types of memory may be used instead of or in addition to those listed above. In the example embodiment illustrated, the content usage data 157 is stored in memory of the head end system 102. However, in other embodiments, the content usage data 157 may be stored elsewhere.

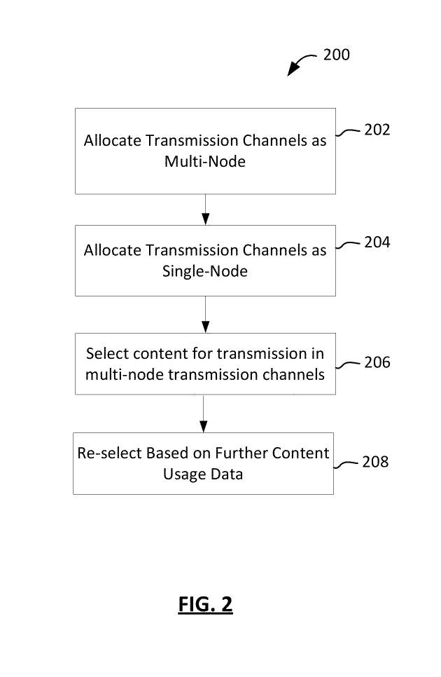

The bandwidth management system 116 will be discussed in greater detail below with reference to FIGS. 2 to 4.

The content delivery system 100 and/or any of the components, features or systems of the content delivery system 100 discussed herein, in at least some embodiments, include one or more processors and one or more memory elements storing computer executable instructions. In at least some embodiments, the content delivery system 100 and/or any of the components, features or systems of the content delivery system 100 may operate under stored program control and execute the computer executable instructions stored on the memory element(s). In at least some embodiments, the bandwidth management system 116 is provided by a processor which executes computer executable instructions.

Furthermore, any of the features of any of the systems included in the head end system 102 may be provided by other systems of the head end system 102 and any one or more of these features may be provided by other systems or subsystems of the head end system 102 not specifically discussed herein. More particularly, the head end system 102 may not be physically or logically divided in the manner illustrated in FIG. 1. In at least some embodiments, components of the head end system 102 may be physically or logically separated from one another. In at least some embodiments, the head end system 102 may be physically separated and may, for example, include a super head end system and one or more regional or local head end systems. The super head end system and/or the regional or local head end systems may separately or collectively perform some of the functions described above with reference to FIG. 1.

In at least some example embodiments, the head end system 102 may be a modular solution in which various functions or features described herein are provided by various modules. Such modules may, for example, be rack mounted electrical devices and may interconnect with one another to collectively provide functions and features described herein. In at least some embodiments, one or more of the modules, features, systems or subsystems described herein may contain one or more processors and a memory having computer readable instructions stored thereon. The computer readable instructions may be executable by the processors and may cause the processors to provide functions described herein.

### Bandwidth Management

Referring now to FIG. 2, an example embodiment of a method 200 for managing bandwidth in accordance with example embodiments of the present disclosure is illustrated in flowchart form.

One or more application or module stored in memory of the content delivery system 100 (such as in the head end system 102 and/or the termination system 113) may be configured to perform the method 200 of FIG. 2. Accordingly, the method 200 may be performed by the content delivery system 100. In at least some example embodiments, a bandwidth management system 116 (FIG. 1) may be configured to perform the method 200 of FIG. 2. More particularly, one or more application or module in the head end system 102, termination system 113 and/or the bandwidth management system 116 may contain computer readable instructions which cause a processor of the head end system 102, termination system 113 and/or a processor of the bandwidth management system 116 to perform the method 200. Accordingly, in some embodiments, the method 200 may be performed by a processor which is internal to the termination system 113 and, in some embodiments, the method 200 may be performed by a processor which is internal to the head end system 102 or another system.

At 202, a predetermined number of the transmission channels which are available to transmit data between the termination system 113 and the nodes 107 are allocated as multi-node transmission channels. Each multi-node transmission channel is configured to distribute content from the termination system 113 to a plurality of nodes 107. In at least some embodiments, each multi-node transmission channel is configured for sending content to all nodes 107 connected to the termination system 113. That is, the multi-node transmission channel is used to effectively broadcast content to the nodes. The termination system 113 and/or the nodes 107 may be configured such that content which is transmitted through the multi-node transmission channel is received at all nodes 107 connected to that termination system 113.

In at least some embodiments, four transmission channels may be allocated as multi-node transmission channels. However, in other embodiments, a different number of transmission channels may be allocated as multi-node transmission channels.

At 204, some transmission channels are allocated as single-node transmission channels. Each single node transmission channel is configured to distribute content from the termination system 113 to a single one of the nodes 107. That is, each single node transmission channel is associated with a specific one of the nodes 107. Content transmitted on the single node transmission channel may be received at the node 107 associated with that transmission channel and not the other nodes 107. That is, the termination system 113 (and/or one or more of the nodes) may be configured such that content which is transmitted through the single-node transmission channel is received at only the node 107 associated with that single-node transmission channel. Accordingly, the single-node transmission channels may be used to effectively narrowcast content to a node 107.

In at least some embodiments, three transmission channels may be allocated as single-node transmission channels for each node. However, in other embodiments, a different number of transmission channels may be allocated as single-node transmission channels.

At 206, content is selected for transmission in the multi-node transmission channels based on content usage data 157. Similarly, content may be selected for transmission in the single-node transmission channels based on the content usage data 157. In at least some embodiments, content which is relatively more popular is transmitted using the multi-node transmission channels and content which is relatively less popular is transmitted using the single-node transmission channels.

The popularity of the content may be determined based on the content usage data 157. The content usage data 157 specifies content consumed by the receivers 104. The content usage data 157 identifies content, identifies usage of such content (for example, using a metric such as viewership for each item of content) and may, in at least some embodiments, identify the receiver or receivers which consumed that content (for example, using a unique identifier associated with receivers which consumed the content).

The form by which content is identified in the content usage data 157 may vary between embodiments. In some embodiments, the content usage data 157 may identify content, at least in part, based on metadata associated with content (which may be metadata from the programming data store 130). That is, the content usage data 157 may track the popularity of content by using one or more identifiers of content contained in the metadata. For example, the content usage data 157 may specify a title of a television series or program and/or may specify a title of an episode. Other data may be used to identify content in other embodiments.

The content usage data 157 may identify content in other ways in other embodiments. For example, in some embodiments, the content may be identified using network or channel identification information (and, in some embodiments, timing information). For example, in some embodiments, the content usage data may identify content using a unique network identifier associated with the network which broadcast the content (such as, for example, a call sign associated with the station). In other embodiments, the content usage data may identify content using a unique channel identifier associated with the network which broadcast the content.

In at least some embodiments, the bandwidth management system 116 may be configured to provide on-the-fly transitioning of content into the multi-node transmission channels. That is, the bandwidth management system 116 may be configured to monitor the content being consumed and to shift content into the multi-node transmission channels based on the popularity of content. That is, the bandwidth management system 116 may be configured to, at 206, select content for transmission in the multi-node transmission channels based on content usage data which represents the current popularity of content. In at least some such embodiments, the content delivery system 100 may continually track content usage and may, continually update the content usage data 157 to reflect current content usage.

In at least some embodiments, content usage data 157 may be obtained in such a manner that it is possible to associate the content usage data 157 with a specific termination system 113. That is, the content usage data 157 may specify or may be used to specify the popularity of content at receivers 104 serviced by a specific termination system 113. For example, in at least some embodiments, the content usage data 157 may identify receivers which consumed content. That is, the content usage data may identify content consumed by receivers 104 connected to the content delivery system 100 and may also identify the receivers 104 consuming that content. Thus, the content usage data 157 may allow the content delivery system 100 to know which receivers 104 viewed which content.

Accordingly, in at least some embodiments, the content usage data 157 allows popular content to be identified on a per-termination system basis. Content which is popular at one termination system 113 may not, in all circumstances and in all embodiments, be popular at another termination system 113. Accordingly, in at least some embodiments, content is selected (at 206) for transmission in the multi-node transmission channels independently for each termination system 113. For example, a first termination system 113 may transmit content in its multi-node transmission channel which is not transmitted in the multi-node transmission channel of a second termination system 113.

In at least some embodiments, content may be selected for transmission in the multi-node transmission channels by correlating topology data 155 with content usage data to identify content which is popular among end user devices (such as receivers 104) serviced by the termination system 113. That is, the topology data 155 may be used to associate a receiver 104 with a termination system 113 and the content usage data 157 may be used to associate a receiver 104 with content consumed by that receiver 104. By correlating such data, the content delivery system 100 is able to identify popular content for the termination system 113. That is, the content delivery system 100 is able to identify content which is popular among the receivers 104 serviced by a specific termination system 113 and to evaluate the relative popularity of content independently for each termination system 113. (i.e. the effect of use by receivers not connected to the termination system may be ignored).

Accordingly, in at least some embodiments, content may be selected for transmission in the multi-node transmission channels for a termination system 113 based on content usage data representing content usage at receivers 104 connected to that termination system 113. That is, content which is popular among the receivers 104 connected to the termination system 113 may be selected for transmission via the multi-node transmission channels of that termination system 113.

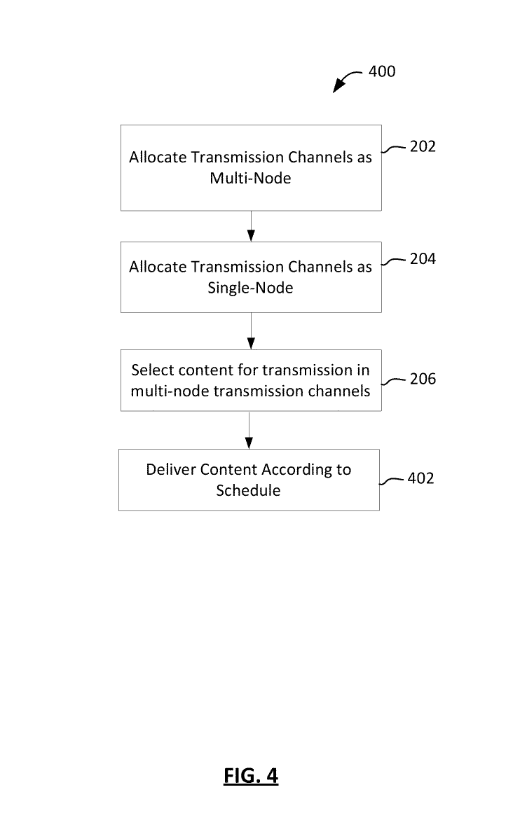

As will be described in greater detail below with reference to FIG. 4, in at least some embodiments, instead of or in addition to on-the-fly transitioning of content (e.g. instead of allocating the multi-node transmission channels based on current content usage), the bandwidth management system 116 may be configured to select content for transmission in the multi-node transmission channels based on content usage data 157 which represents historical usage data identifying the historic popularity of content. For example, as will be described in greater detail below with reference to FIG. 4, in some embodiments, the bandwidth management system 116 may be configured to obtain a content delivery schedule based on such historic usage data. The content delivery schedule may specify content to be delivered over the multi-node transmission channels and may specify timing information associated with such content. For example, the content delivery schedule may be comprised of thirty (30) minute time slots which begin on each hour and each half hour. The content delivery schedule may specify content to be delivered using the multi-node transmission channels of the termination system 113 at each time slot.

In at least some embodiments, at 206 content may be selected for each of the multi-node transmission channels of a termination system. For example, in an embodiment in which there are four multi-node transmission channels, the four most popular items of content may be selected and delivery through the four multi-node transmission channels.

The content which is selected for transmission using the multi-node transmission channels may be transmitted using the multi-node transmission channels and other content may be transmitted using the single-node transmission channels.

In some embodiments, after content has been selected for transmission in the multi-node transmission channels, the content delivery system 100 may (at 208) re-evaluate the selection based on further content usage data. That is, in at least some embodiments, after content has been selected for delivery using the multi-node transmission channels, the content delivery system 100 may reselect content for transmission in the multi-node transmission channels based on further content usage data. In some embodiments, if content which is being transmitted in single-node transmission channels becomes more popular than content which is being transmitted in a multi-node transmission channel, then the content delivery system may begin transmitting the newly popular content in the multi-node transmission channels and may begin transmitting the newly unpopular content in one or more single-node transmission channels.

The method 200 may be performed for a specific termination system 113. That is, the method 200 may be performed to manage bandwidth for a specific termination system 113. Each termination system 113 may, in at least some embodiments, be independently managed. That is, content which is selected for transmission in multi-node transmission channels of a termination system 113 may not, in all embodiments, be selected for transmission in multi-node transmission channels of another termination system 113. The method 200 may, in at least some embodiments, be repeated. For example, the method 200 may be performed for each termination system 113 so that bandwidth is independently managed for each termination system.

### Example Content Usage Data

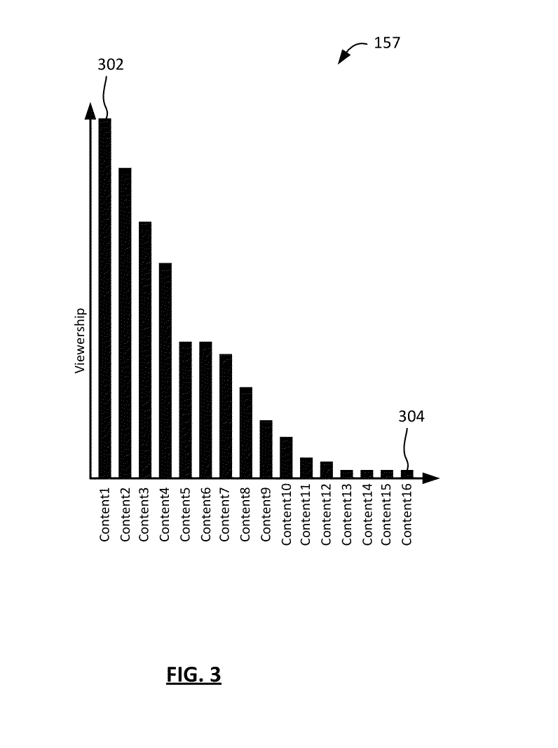

Referring now to FIG. 3, example filtered content usage data 157 will be described. In the example embodiment of FIG. 3, the content usage data 157 is displayed in bar graph format. The content usage data specifies the popularity of various content on end user devices (e.g. receivers 104) serviced by the content delivery system 100. The content usage data illustrated in FIG. 3 may have been filtered by the bandwidth management system to illustrate content usage for a specific termination system 113 (e.g. it may represent usage for only the receivers connected to that termination system 113) and/or for timing information (e.g. it may represent usage during a specific time slot).

In the example, the content usage data 157 quantifies viewership for a number of different content items. The content usage data 157 may be arranged by popularity. More popular content may be arranged in the leftmost portion of the bar graph and less popular content may be arranged in the rightmost portion of the bar graph. Content which is to the left of other content in the bar graph is at least as popular as that other content.

The content usage data 157 illustrated may have been filtered to identify content usage at a specific termination system 113. That is, the content usage data 157 may quantify viewership of content for receivers 104 connected to a specific termination system 113.

Similarly, the content usage data 157 may have been filtered to identify content usage at a specific point in time. For example, in some embodiments, the content usage data 157 may quantify content consumption of various content items at receivers 104 at the current time. In other embodiments, the content usage data 157 may quantify content consumption of various content items at receivers 104 at a historic time. For example, in some embodiments, the content usage data 157 represented by way of example in FIG. 3 may represent content usage during a specific time slot. For example, the content usage data 157 may represent content usage during a specific half-hour time slot during a specific day of the week.

From the content usage data 157 it is possible to identify short tail content 302 (which may also be referred to as popular content) and long tail content 304 (which may also be referred to as unpopular or less-popular content). The short tail content 302 is the content to the left in the bar graph when the bar graph is arranged according to popularity and the long tail content 304 is the content to the right in the bar graph when the bar graph is arranged according to popularity.

Accordingly, in at least some embodiments, at 206 of the method 200 of FIG. 2, the content delivery system 100 may use content usage data 157, such as the filtered content usage data of FIG. 3, to identify short tail content and comparatively long tail content. The content delivery system 100 may configure a termination system 113 to distribute the short tail content over multi-node transmission channels and may configure the termination system 113 to distribute the comparatively long tail content over the single-node transmission channels.

### Bandwidth Management

Referring now to FIG. 4, a further example embodiment of a method 400 for managing bandwidth in accordance with example embodiments of the present disclosure is illustrated in flowchart form.

One or more application or module stored in memory of the content delivery system 100 (such as in the head end system 102 and/or the termination system 113) may be configured to perform the method 400 of FIG. 4. Accordingly, the method 400 may be performed by the content delivery system 100. In at least some example embodiments, a bandwidth management system 116 (FIG. 1) may be configured to perform the method 400 of FIG. 4. More particularly, one or more application or module in the head end system 102, termination system 113 and/or the bandwidth management system 116 may contain computer readable instructions which cause a processor of the head end system 102, termination system 113 and/or a processor of the bandwidth management system 116 to perform the method 400. Accordingly, in some embodiments, the method 400 may be performed by a processor which is internal to the termination system 113 and, in some embodiments the method 400 may be performed by a processor which is internal to the head end system 102 or another system.

The method 400 may be performed to schedule an efficient use of multi-node transmission channels based on the content usage data 157. That is, content usage data which describes historic usage of content by the receivers 104 may be used in order to predict future demand for content. Content which is expected to be highly demanded may be transmitted using multi-node transmission channels and content for which there is expected to be less demand may be transmitted using single-node transmission channels.

The method 400 of FIG. 4 includes features which are described in greater detail above with reference to FIG. 2. For example, at 202, a predetermined number of transmission channels are allocated as multi-node transmission channels and, at 204, transmission channels are allocated as single-node transmission channels.

As discussed above with reference to the method 200 of FIG. 2, at 206, content may be selected for transmission using the multi-node transmission channels. More particularly, content may be selected for transmission using the multi-node transmission channels based on the content usage data 157.

While the discussion of the method 200 of FIG. 2 described the use of current content usage data, (defining content currently being consumed by receivers 104), in at least some embodiments, at 206 content may be selected for transmission in the multi-node transmission channels based on historic content usage data 157 identifying the historic popularity of content. For example, in some embodiments, at 206, a content delivery schedule is obtained based on such historic usage data. In at least some such embodiments, the content usage data 157 may include timing information such as, for example, information specifying a time slot during which content was consumed.

For example, in some embodiments, content may be selected for transmission in the multi-node transmission channels by identifying content which was previously popular during the same time slot. For example, the content delivery system 100 may identify content which is expected to be popular during various time slots throughout the day (the time slots may, for example, be thirty minute time slots) and may generate a schedule which controls use of the multi-node transmission channels based on the identified content. In at least some embodiments, the content delivery system 100 may identify popular content for a time slot by identifying content which was previously popular during the same time on the same day of the week. For example, the content delivery system 100 may identify the channels and/or networks which with the greatest viewership during each time slot.

As discussed previously, the selection of content for delivery in the multi-node transmission channels may be performed on a per-termination system basis. That is, a schedule may be independently generated for each termination system based on content usage data associated with receivers 104 serviced by that termination system 113.

The content delivery schedule may specify content to be delivered over the multi-node transmission channels and may specify timing information associated with such content. For example, the content delivery schedule may be comprised of thirty (30) minute time slots which begin on each hour and each half hour. The content delivery schedule may specify content to be delivered using the multi-node transmission channels of the termination system 113 at each time slot.

After the content delivery schedule is generated, at 402, the content delivery system 100 may deliver content according to the content delivery schedule. For example, at the start of the time slots in the content delivery schedule, the content delivery system 100 may switch an input feed associated with a multi-node transmission channel in accordance with the content delivery schedule. That is, the content delivery system 100 may transition content in and out of the multi-node transmission channels based on the content delivery schedule.

The method 400 may be performed for a specific termination system 113. That is, the method 400 may be performed to manage bandwidth for a specific termination system 113. Each termination system 113 may, in at least some embodiments, be independently managed. That is, content which is selected for transmission in multi-node transmission channels of a termination system 113 may not, in all embodiments, be selected for transmission in multi-node transmission channels of another termination system 113. The method 400 may, in at least some embodiments, be repeated. For example, the method 400 may be performed for each termination system 113 so that bandwidth is independently managed for each termination system.

While the method 200 of FIG. 2 generally described the use of current content usage data (i.e. data identifying content currently being consumed) and the method 400 of FIG. 4 generally described the use of historic content usage data (i.e. data identifying content previously consumed), in at least some embodiments, both current content usage data and historic content usage data may be used in order to efficiently use the multi-node transmission channels. For example, in at least some embodiments, historic content usage data may be used in order to schedule the use of the multi-node transmission channels as described with reference to FIG. 4 and current content usage data may be used in order to ensure that the predictions regarding which content will be popular accord with actual demand for content. In at least some embodiments, at the beginning of each time slot content will be delivered using the multi-node transmission channels according to the content delivery schedule. After these initial assignments of content to the multi-node transmission channels, the content delivery system 100 may continue to monitor demand for content and may move content in and out of the multi-node transmission channels based on current usage data which identifies actual demand for content.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method, performed by a content delivery system, the content delivery system comprising a termination system configured to deliver content to a plurality of nodes over a plurality of transmission channels, the method comprising:
allocating transmission channels as multi-node transmission channels, each multi-node transmission channel being configured to distribute content from the termination system to a plurality of nodes;
allocating transmission channels as single-node transmission channels, each single-node transmission channel being configured to distribute content from the termination system to a single node; and
selecting content for transmission in the multi-node transmission channels based on content usage data.

2. The method of claim 1, wherein the content usage data is historical usage data identifying historic popularity of content.

3. The method of claim 2, wherein selecting content for transmission in the multi-node transmission channels comprises:
obtaining a content delivery schedule based on the historical usage data, the content delivery schedule specifying content to be delivered over the multi-node transmission channels and timing information associated with such content.

4. The method of claim 3, further comprising:
delivering content according to the content delivery schedule.

5. The method of claim 4, wherein delivering content according to the content delivery schedule comprises:
switching an input feed associated with a multi-node transmission channel in accordance with the content delivery schedule.

6. The method of claim 1, wherein the content usage data is current usage data representing a current popularity of content.

7. The method of claim 6, further comprising, after selecting content:
reselecting content for transmission in the multi-node transmission channels based on further content usage data.

8. The method of claim 1, wherein the content usage data specifies the popularity of various content on end user devices serviced by the content delivery system.

9. The method of claim 1, wherein selecting content for transmission in the multi-node transmission channels comprises:
correlating topology data with content usage data to identify content which is popular among end user devices serviced by the termination system.

10. The method of claim 1, wherein each node is associated with a plurality of end user devices.

11. The method of claim 1, wherein selecting content for transmission in the multi-node transmission channels comprises:
identifying short tail content and comparatively long tail content based on the content usage data;
configuring the termination system to distribute the short tail content over multi-node transmission channels; and
configuring the termination system to distribute the comparatively long tail content over the single-node transmission channels.

12. The method of claim 1, wherein selecting content for transmission in the multi-node transmission channels comprises ignoring content usage data for receivers not serviced by the termination system.

13. A content delivery system for delivering content to a plurality of end user devices, the end user devices being connected to a node of the content delivery system, the content delivery system comprising:
at least one termination system for delivering content to a plurality of the nodes over a plurality of transmission channels;
a memory;
a processor coupled to the memory and the termination system, the processor being configured to:
allocate transmission channels as multi-node transmission channels, each multi-node transmission channel being configured to distribute content from the termination system to a plurality of nodes;
allocate transmission channels as single-node transmission channels, each single-node transmission channel being configured to distribute content from the termination system to a single node; and
select content for transmission in the multi-node transmission channels based on content usage data.

14. The content delivery system of claim 12, wherein the processor is internal to the termination system.

15. The content delivery system of claim 13, wherein the content usage data is historical usage data identifying historic popularity of content.

16. The content delivery system of claim 15, wherein selecting content for transmission in the multi-node transmission channels comprises:
obtaining a content delivery schedule based on the historical usage data, the content delivery schedule specifying content to be delivered over the multi-node transmission channels and timing information associated with such content.

17. The content delivery system of claim 16, wherein the processor is further configured to:
deliver content according to the content delivery schedule.

18. The content delivery system of claim 17, wherein delivering content according to the content delivery schedule comprises:
switching an input feed associated with a multi-node transmission channel in accordance with the content delivery schedule.

19. The content delivery system of claim 13, wherein selecting content for transmission in the multi-node transmission channels comprises:
correlating topology data with content usage data to identify content which is popular among end user devices serviced by the termination system.

20. A computer readable storage medium comprising computer executable instruction which, when executed, cause a processor to:
allocate transmission channels as multi-node transmission channels, each multi-node transmission channel being configured to distribute content from the termination system to a plurality of nodes;
allocate transmission channels as single-node transmission channels, each single-node transmission channel being configured to distribute content from the termination system to a single node; and
select content for transmission in the multi-node transmission channels based on content usage data.
